(19) United States
(12) Patent Application Publication
(10) Pub. No.: US 2015/0153876 A1
(43) Pub. Date: Jun. 4, 2015

(54) TOUCH DISPLAY DEVICE

(71) Applicant: InnoLux Corporation, Miao-Li County (TW)

(72) Inventors: Charles CHIEN, Miao-Li County (TW); I-Chieh CHU, Miao-Li County (TW)

(21) Appl. No.: 14/536,860

(22) Filed: Nov. 10, 2014

(30) Foreign Application Priority Data
Nov. 29, 2013 (TW) 102143699

(51) Int. Cl. G06F 3/044

(52) U.S. Cl. CPC G06F 3/044; G06F 2203/04107

(57) ABSTRACT

The present invention relates to a touch display device, comprising: a display device; and a touch panel disposed on a side of the display device, wherein the touch panel comprises: a substrate; a shielding layer disposed between the substrate and the display device; and a wiring layer disposed between the shielding layer and the display device, comprising: a first signal electrode comprising a first overlap region and a first non-overlap region; and a second signal electrode comprising a second overlap region and a second non-overlap region; wherein the first overlap region and the second overlap region overlap with the shielding layer; and a spacing between the first overlap region and the second overlap region is greater than a spacing between the first non-overlap region and the second non-overlap region.

### CROSS REFERENCE TO RELATED APPLICATION

This application claims the benefits of the Taiwan Patent Application Serial Number 102143699, filed on Nov. 29, 2013, the subject matter of which is incorporated herein by reference.

### BACKGROUND OF THE INVENTION

1. Field of the Invention

The present invention relates to a touch display device, and especially to a touch display device which can prevent the black matrix from the internal electrostatic damaging.

2. Description of Related Art

Recently, with the development trend of user-friendly operation and simplicity, touch display devices are becoming more and more widely used in the production and life. Since the user can input signals directly by hand or other objects to access the touch display device, the user's dependence on other input devices (such as a keyboard, a mouse, a remote controller and so on) are thus reduced or even eliminated, thereby greatly facilitating the user's operation.

The touch panel technique may be divided into various types according to three main aspects: signal generating principle, sensing technique, and the way of screen assembly. According to the signal generating principle, it may be divided into digital type and analog type. The digital type touch signal is generated by employing a transparent indium tin oxide (ITO) conductive film, on which wirings are distributed along the directions of X axis and Y axis, forming a switch at a crossover of the wirings, which generates the tough signal when a pressure is applied. On the other hand, analog type is different from digital type by a dot spacer disposed between the upper and lower electrode layers, and when a touch applied, the upper and lower electrode layers are connected to generate a signal representing the potential difference, which is then transferred to a controller by a circuit to process and calculate the coordinate position of the touch spot. Furthermore, according to sensing technique, the touch panel technique may be divided into electric signal (including resistive type, capacitive type, electromagnetic type, and so on), light signal (including infrared type and the like), and sound signal (including surface acoustic wave type, acoustic waveguide type, chromatic dispersion signal type, sound pulse type, and so on).

However, in the manufacturing process of the touch panel, the backend-process temperature may carbonize the black matrix (BM) material and result in a reduced resistance, making the black matrix slightly conductive. In such circumstances, the surface portion of the electrode with a smaller radius of curvature or a sharp angle (i.e. the narrower portion) has a higher charge density and higher electric field intensity. Therefore, when the charge continues to accumulate, a large voltage difference will be formed and electro-static discharge (ESD) will be induced to damage the black matrix, which ultimately results in the light leakage or short-circuit problem.

Accordingly, what is needed is to develop a touch display panel, wherein the surface with a smaller radius of curvature or a sharp angle is avoided in the electrode region, to prevent the black matrix from the internal electrostatic damaging during the manufacturing process.

### SUMMARY OF THE INVENTION

An object of the present invention is to provide a touch display device, which can prevent black matrix from electrostatic damage due to the charge accumulation on the surface with a smaller radius of curvature or sharp corners during the touch panel manufacturing process.

To achieve the object, the present invention provides a touch display device, comprising: a display device; and a touch panel disposed on a side of the display device, wherein the touch panel comprises: a substrate; a shielding layer disposed between the substrate and the display device; and a wiring layer disposed between the shielding layer and the display device, comprising: a first signal electrode comprising a first overlap region and a first non-overlap region; and a second signal electrode comprising a second overlap region and a second non-overlap region; wherein the first overlap region and the second overlap region overlap with the shielding layer; and a spacing between the first overlap region and the second overlap region is greater than a spacing between the first non-overlap region and the second non-overlap region.

Accordingly, since the touch display device of the present invention has a larger spacing than conventional touch panels at the overlapping region, the charge on the electrode region will be evenly distributed and will not easily accumulate at some specific regions, thus preventing electrostatic damage during the manufacturing process of the touch panel and improving the process yield.

Other objects, advantages, and novel features of the invention will become more apparent from the following detailed description when taken in conjunction with the accompanying drawings.

### BRIEF DESCRIPTION OF THE DRAWINGS

FIG. 1 shows a schematic diagram of the touch panel according to an embodiment of the present invention.

FIG. 2 shows an enlarged view of the corner region of FIG. 1.

FIG. 3 shows a partial enlarged view of FIG. 2.

FIGS. 4A and 4B show partial enlarged views of FIG. 3

FIG. 4C shows a schematic diagram of another embodiment of FIG. 4A.

FIG. 5 shows a sectional view along the wiring a-b of FIG. 4A.

FIG. 6 shows a schematic diagram of the touch display device according to an embodiment of the present invention.

FIG. 7 shows a partial enlarged view of the touch display device according to a comparative embodiment.

### DETAILED DESCRIPTION OF THE PREFERRED EMBODIMENT

The present invention will now be explained in further detail with reference to the following examples. However, these examples are merely illustrative of the present invention, the scope of which shall not be construed to be limited by the following examples.

### EXAMPLE

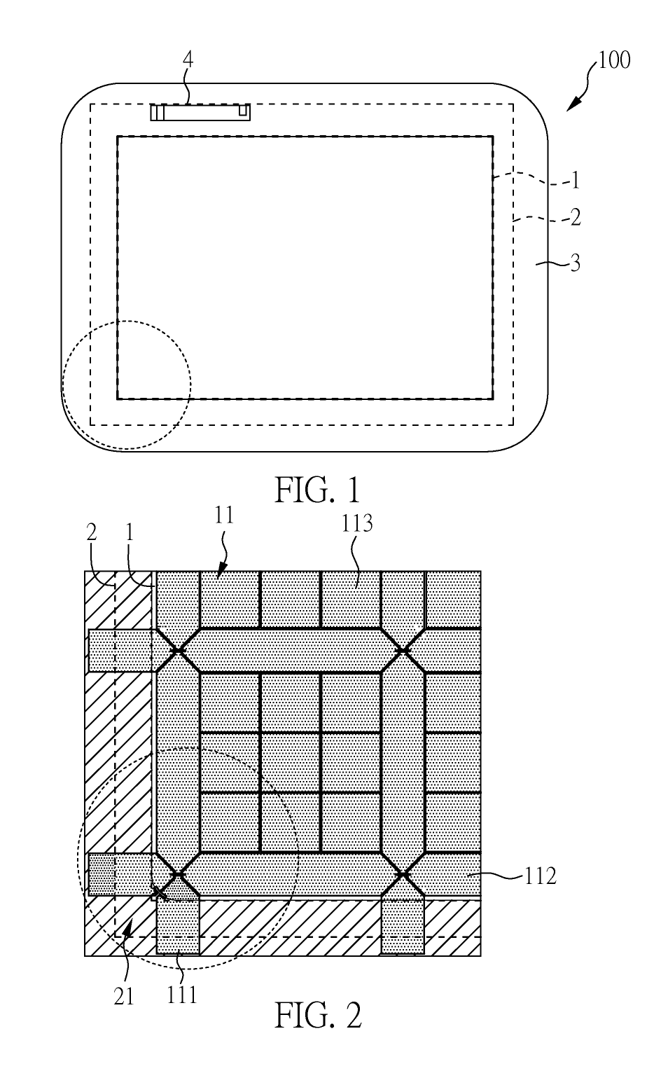

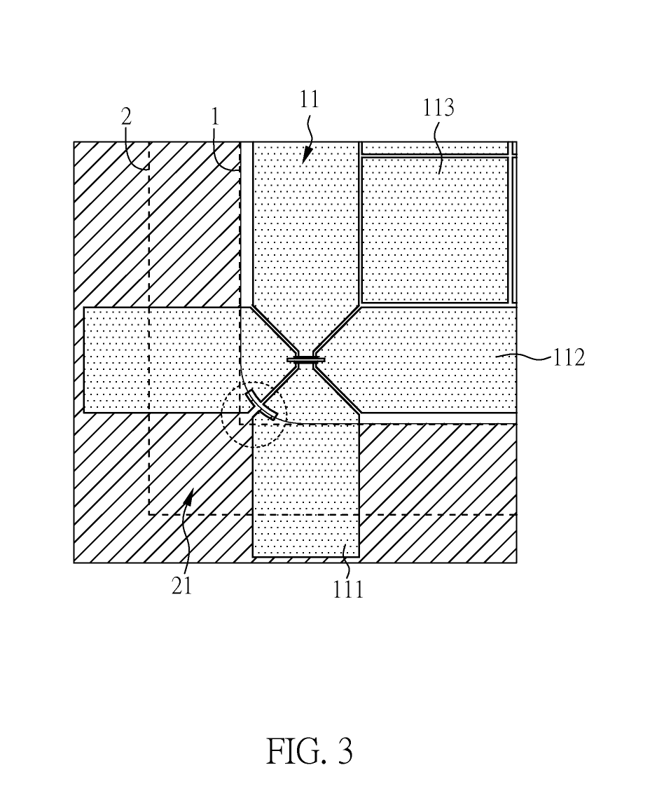

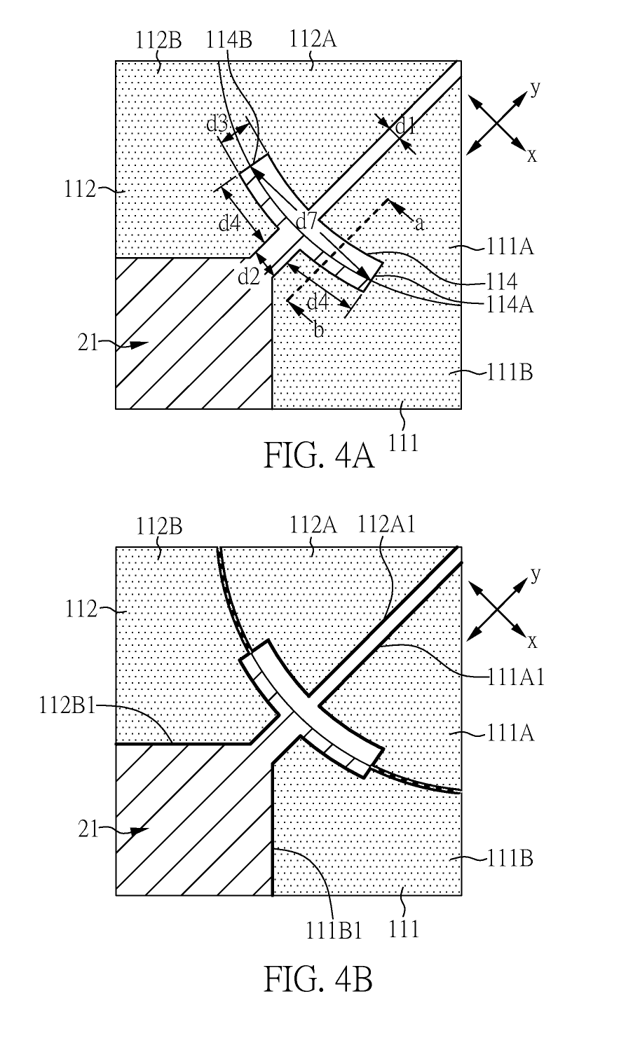

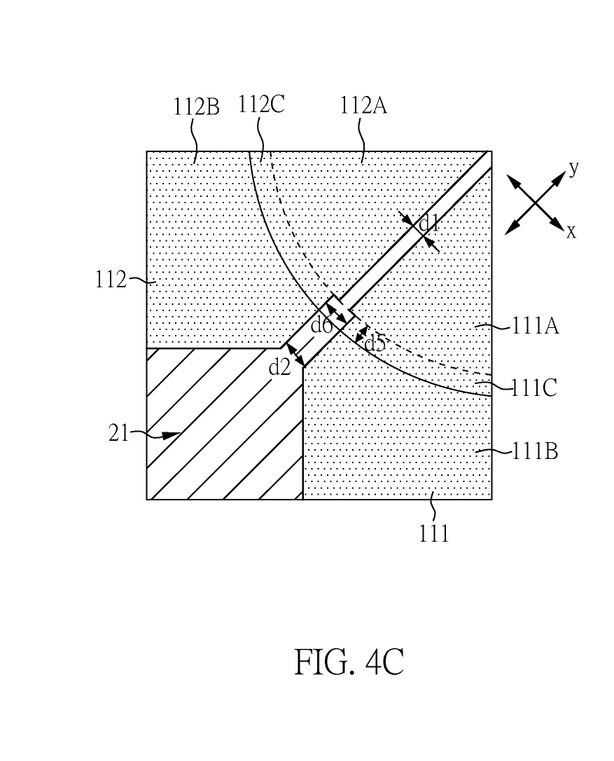

FIG. 1 shows a schematic diagram of the touch panel according to an embodiment of the present invention. As shown in FIG. 1, the touch panel 100 is divided into the sense region 1, the edge region 2, the frame 3 and the wiring region 4, wherein the enlarged view of the corner region (encircled by a dotted line) of the panel is shown in FIG. 2. Referring to FIG. 2, a wiring layer 11 of the touch panel 100 includes a first signal electrode 111, a second signal electrode 112, and a dummy electrode 113, and the wiring layer 11 is disposed above a shielding layer 21, wherein the enlarged view of the corner region (encircled by a dotted line) of the panel is shown in FIG. 3; and the enlarged view of portions (encircled by a dotted line) of the first signal electrode 111 and the second signal electrode 112 of FIG. 3 is shown in FIG. 4A.

Referring to FIG. 4A, the first signal electrode 111 includes a first non-overlap region 111A and a first overlap region 111B, and the second signal electrode 112 includes a second non-overlap region 112A and a second overlap region 112B, wherein the first overlap region 111B and the second overlap region 112B correspond to the shielding layer 21, and a spacing d2 between the first overlap region 111B and the second overlap region 112B is greater than a spacing d1 between the first non-overlap region 111A and the second non-overlap region 112A. For example, the spacing d1 between the first non-overlap region 111A and the second non-overlap region 112A is generally about 30 μm, and the spacing d2 between the first overlap region 111B and the second overlap region 112B may be 1.5-10 times, and preferably 2-5 times the spacing d1 between the first non-overlap region 111A and the second non-overlap region 112A. Alternatively, when the spacing d1 between the first non-overlap region 111A and the second non-overlap region 112A is varied according to the size or some specific needs, the spacing d2 between the first overlap region 111B and the second overlap region 112B may be 40 to 300 μm, and preferably 60-100 μm. Here, in FIGS. 4A and 4B, x and y directions are defined based on the spacing of the first non-overlap region 111A and the second non-overlap region 112A, wherein the widthwise direction of the spacing is defined as x, and lengthwise direction of the spacing is defined as y; and x and y directions are perpendicular to each other.

Further, FIG. 4A also shows that an aperture region 114 may be further included between the first non-overlap region 111A and the second non-overlap region 112A, and between the first overlap region 111B and the second overlap region 112B, and wherein a part of the aperture region corresponds to the shielding layer 21. The parts that correspond and not correspond to the shielding layer 21 are not specifically limited, and the area proportion of the two can be appropriately adjusted by the person skilled in the art. The width d3 of the aperture region 114 between the first non-overlap region 111A and the second non-overlap 112A in the y direction (i.e., the spacing of the aperture region 114 between the first and the second non-overlap regions 111A, 112A and the first and the second overlap region 111B, 112B at the aperture region 114) may be 0.2-2 times the spacing d1 (typically about 30 μm) between the first non-overlap region 111A and the second non-overlap region 112A, or in other words, the width d3 may be 0.6-60 μm, but the present invention is not limited thereto. Furthermore, the aperture region 114 extends a distance d4 from one side of the first and the second overlap regions 111B, 112B to another side in a direction x, wherein the direction x is the widthwise direction of the spacing d1 between the first and the second non-overlap regions 111A, 1112A. The distance d4 is 3-10 times the spacing d1 (typically about 30 μm) between the first and the second non-overlap regions 111A, 112A, or in other words, the width d4 may be 100-1000 μm, but the present invention is also not limited thereto. In detail, the extension distance d4 of the aperture region 114 from a side of the first overlap region 111B in the direction x is the distance d4 between a side 114A of the aperture region 114 and the side of the first overlap region 111B, and the side 114A of the aperture region 114 is between the first non-overlap region 111A and the first overlap regions 111B. Similarly, the extension distance d4 of the aperture region 114 from a side of the second overlap region 112B in the direction x is the distance d4 between another side 114B of the aperture region 114 and the side of the second overlap region 112B, and the side 114B of the aperture region 114 corresponds to the side 114A, and is between the second non-overlap region 112A and the second overlap regions 111B. In the case that the aperture region 114 is provided, the length d7 of the aperture region 114 can be measured, which should be the sum of twice the distance d4 of the aperture region 114 from a side of the first overlap region 111B in the direction x and the spacing d2 between the first and second overlap regions 111B, 112B.

FIG. 4A and FIG. 4B are the enlarged partial views of FIG. 3. As shown in FIG. 4B, the first non-overlap region 111A has a first non-overlap region edge 111A1, the second non-overlap region 112A has a second non-overlap region edge 112A1, the first overlap region 111B has a first overlap region edge 111B1, and the second overlap region 112B has a second overlap region edge 112B1. In FIG. 4B, the first non-overlap region edge 111A1, the second non-overlap region edge 112A1, the first overlap region edge 111B1, and the second overlap region edge 112B1 are shown by a bold black line, and the adjacent areas are separated by dashed lines. The minimal spacing between the first overlap region edge 111B1 and the second overlap region edge 112B1 is greater than the minimal spacing between the first non-overlap region edge 111A1 and the second non-overlap region edge 112A1, but the present invention is not limited thereto.

Alternatively, referring to FIG. 4C, showing a schematic diagram of another embodiment of FIG. 4A, a first signal electrode 111 includes the first non-overlap region 111A and the overlap region 111B, and may further include a first connection region 111C disposed therebetween, and the second signal electrode 112 includes a second non-overlap region 112A and second overlap region 112B, and may further include a second connection region 112C disposed therebetween. The width d5 of the first and the second connection regions 111C, 112C in the lengthwise direction y of the spacing between the first and second non-overlap regions 111A, 112A, (i.e., the spacing between the first and second non-overlap regions 111A, 112A and the first and second overlap regions 111B, 112B) is not limited, preferably be 0.1 to 1 times the spacing d1 between the first and second non-overlap region 111A, 112A (typically about 30 micrometers). In other words, the width d5 may be 0.3 to 30 μm. Further, the spacing d6 between the first and the second connection regions 111C, 112C is not limited, and for example, the spacing d6 is preferably defined the same as the spacing d2 between the first and the second overlap regions 111B, 112B. In the embodiment of FIG. 4C, the spacing d1 and the spacing d2 are defined the same as in FIG. 4A.

According to the two embodiments of FIG. 4A and FIG. 4C, the spacing d2 between the first and the second overlap regions 111B, 112B is greater than the spacing d1 between the first and the second non-overlap regions 111A, 112A. The design with a smaller radius of curvature is avoided in the electrode region to evenly distribute charges and to avoid charge accumulation in some specific regions. In addition, since the static electricity is inversely proportional to the square of the distance, the static electricity and electro-static discharge can be thereby decreased. Therefore, the spacing d2 being greater than the spacing d1 can effectively prevent the black matrix from the electrostatic damaging during the manufacturing process.

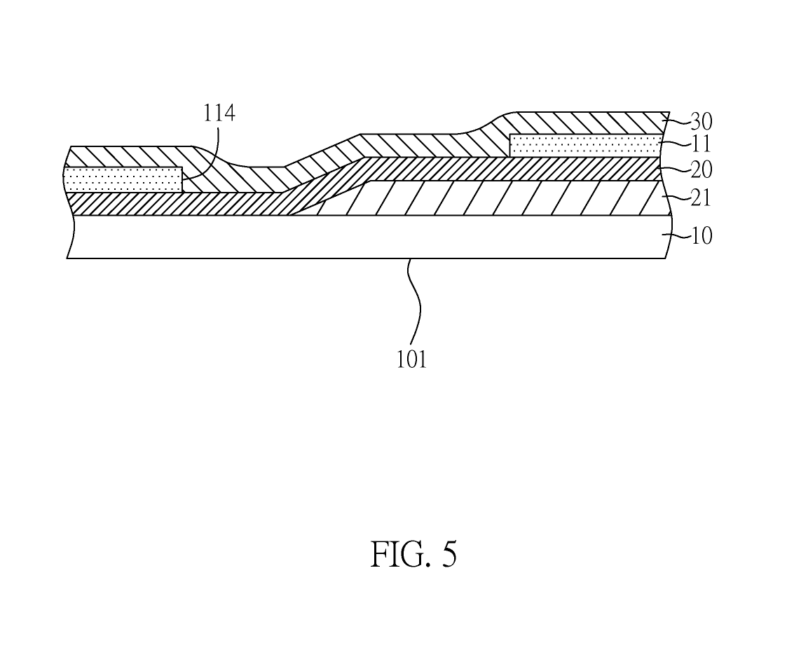

FIG. 5 shows a sectional view along the wiring a-b of FIG. 4A. Referring to FIG. 5, the touch panel according to embodiments of the present invention sequentially comprises: a substrate 10, a shielding layer 21, an optical thin film layer 20, a wiring layer 11, a protective layer 30, and a touch surface 101 of the substrate 10. Because the difference in height is formed by the light-shielding layer 21, uneven thickness of the top coating on the shielding layer 21 is present at the step height, and the first signal electrode 111 and the second signal electrode 112 are easily connected to each other to result in a short circuit. Therefore, in the case that wiring layer 11 includes the aperture region 114, the first signal electrode 111 is further away from the second signal electrode 112 to avoid the above discussed short-circuit. Accordingly, the purpose of setting the optical thin film layer 20 is typically to make the pattern of the touch electrode (i.e. the wiring layer 11) imperceptible for users, and the optical thin film layer 20 may be optionally set or omitted as per requirements. Generally, the substrate 10 may be a glass substrate, the shielding layer 21 may be carbon black, the optical thin film layer 20 may be made of silicon oxynitride (SiOxNy), the wiring layer 11 may be made of indium tin oxide (ITO), and the protective layer 30 may be an acrylic-based material; but the present invention is not limited thereto.

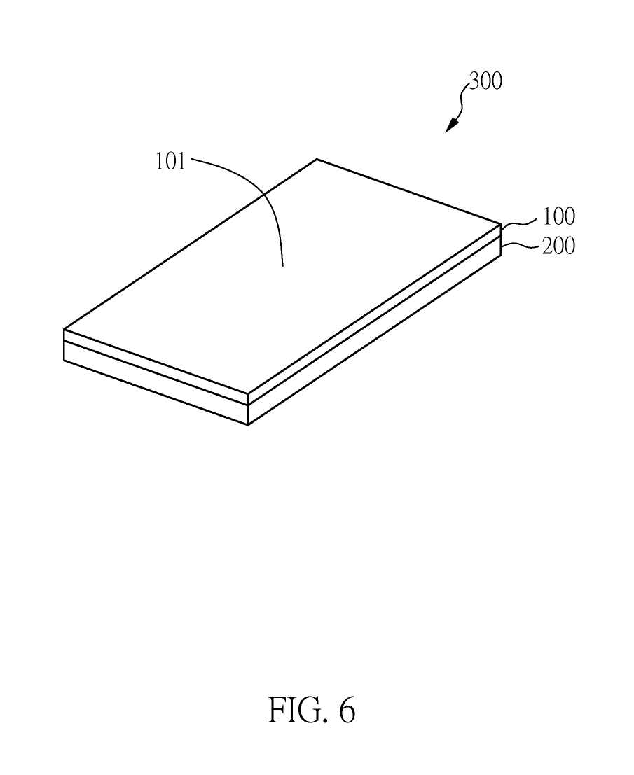

The touch display device of the present invention is shown in FIG. 6, wherein the above-described touch panel 100 is applied in a display device 200. For ease of illustration, the touch panel 100 structure (i.e., the substrate 10, the shielding layer 21, the optical thin film 20, the wiring layer 11 and the protective layer 30 in FIG. 5) are omitted in FIG. 6. The touch display device 300 comprises: a display device 200; and a touch panel 100 disposed on a side of the display device 200; wherein users observes the touch display device 300 from the touch surface 101. In summary, the touch panel 100 may be applied to any device which needs a touch panel, and is not particularly limited. The display device 200 may be a variety of flat panel displays, for example, a liquid crystal display, an organic light-emitting display, or an electronic paper display etc.; and the examples of the practical applications may be: a car display, an electromagnetic isolation glass, a cell phone, a solar cell, a portable LCD video game, an LCD panel for home appliances, an instrument display, a notebook computer, an LCD television, a plasma display, an electrode for a color filter, combinations thereof, and the like.

### Test Example

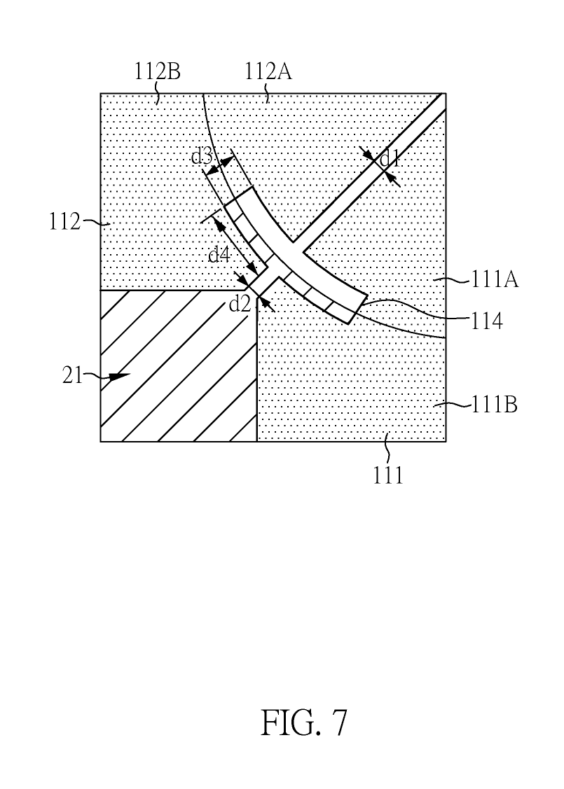

A 13.3-inch touch display device was used for the test, wherein the touch display device of the experimental group was as described in the embodiment of FIG. 4A. The spacing d1 between the first and the second non-overlap regions 111A, 112A was approximately 30 μm; the spacing d2 between the first and the second overlap regions 111B, 112B was about 60 μm; about half area of the aperture region 114 corresponded to the underlying shielding layer 21; the width d3 of the aperture region 114 between the first non-overlap region 111A and the second non-overlap 112A in the lengthwise direction was about 60 μm; and the distance d4 of the aperture region 114 between the first overlap region 111B and the second overlap 112B in the x direction was about 100 μm. Furthermore, referring to FIG. 7, the touch display device of the control group was substantially the same as the experimental group, except that the spacing d2 between the first and the second overlap regions 111B, 112B was about 30 μm.

Referring to both FIG. 1 and FIG. 2, an electrostatic gun (format: 1.5KΩ/100 pF) was used to directly contact the wiring layer 11 of the sensing region 1 for an electrostatic-discharge tolerance test. The strength of the test voltage was gradually incremented from ±0.5V, and ±1V, and a discharge was required after each contact to prevent the charge accumulation. During the test process, the operator wore an anti-static ring, and the wiring region of the touch panel 100 was connected to a ground wire. The result of the electro-static discharge tolerance is summarized in Table 1 below.

TABLE 1

| Touch display device | Fail Voltage |
|---|---|
| Experimental group | +11 KV |
| Control group | +4 KV |

Accordingly, in the touch display device of the control group (referring to FIG. 6), when the voltage of the electro-static discharge (ESD) was greater than +4 KV, the spacing d2 between the overlap regions 111B, 112B may induce the static electricity to damage the shielding layer 21, causing fracture of a small area of the shielding layer 21 and resulting in light leakage at the corner of the sensing region. In contrast, the touch display device (referring to FIG. 4A) of the experimental group, the ESD tolerance was improved to +11 KV, that is, only until the voltage of the ESD was greater than +11 KV, the ESD damage of the shielding layer 21 may occur. In view of the above, the larger spacing d2 between the overlap regions 111B, 112B can evenly distribute charges, thus effectively preventing the electrostatic damage, and improving the process yield.

It should be understood that these examples are merely illustrative of the present invention and the scope of the invention should not be construed to be defined thereby, and the scope of the present invention will be limited only by the appended claims.

What is claimed is:

1. A touch display device, comprising:
a display device; and
a touch panel disposed on a side of the display device,
wherein the touch panel comprises:
a substrate;
a shielding layer disposed between the substrate and the display device; and
a wiring layer disposed between the shielding layer and the display device, and the wiring layer comprising:
a first signal electrode comprising a first overlap region and a first non-overlap region; and
a second signal electrode comprising a second overlap region and a second non-overlap region;
wherein the first overlap region and the second overlap region overlap with the shielding layer; and a spacing between the first overlap region and the second overlap region is greater than a spacing between the first non-overlap region and the second non-overlap region.

2. The touch display device of claim 1, wherein the spacing between the first overlap region and the second overlap region is 1.5-10 times the spacing between the first non-overlap region and the second non-overlap region.

3. The touch display device of claim 1, wherein the spacing between the first overlap region and the second overlap region is 40-300 μm.

4. The touch display device of claim 1, wherein the first overlap region has a first overlap region edge, the first non-overlap region has a first non-overlap region edge, the second overlap region has a second overlap region edge, and the second non-overlap region has a second non-overlap region edge; wherein the minimal spacing between the first overlap region edge and the second overlap region edge is greater than the minimal spacing between the first non-overlap region edge and the second non-overlap region edge.

5. The touch display device of claim 1, wherein an aperture region is provided between the first overlap region and the first non-overlap region and between the second overlap region and the second non-overlap region, wherein a part of the aperture region corresponds to the shielding layer.

6. The touch display device of claim 5, wherein a width of the aperture region is 0.2-2 times the spacing between the first non-overlap region and the second non-overlap region.

7. The touch display device of claim 5, wherein the aperture region has a width of 0.6-60 μm.

8. The touch display device of claim 5, wherein a width of the aperture region is the same as the spacing between the first non-overlap region and the second non-overlap region.

9. The touch display device of claim 5, wherein the aperture region extends respectively from a side of the first overlap region and a side of the second overlap region in a widthwise direction of a spacing between the first non-overlap region and the second non-overlap region, to a distance 3-10 times the spacing between the first non-overlap region and the second non-overlap region.

10. The touch display device of claim 5, wherein the aperture region extends respectively from a side of the first overlap region and a side of the second overlap region in a widthwise direction of a spacing between the first non-overlap region and the second non-overlap region, to a distance of 100-1000 μm.
